(19) United States
(12) Patent Application Publication
(10) Pub. No.: US 2010/0147668 A1
(43) Pub. Date: Jun. 17, 2010

(54) THIN FILM SWITCH

(75) Inventor: HSIEN-TSAN CHANG, Pingtung County (TW)

Correspondence Address: WPAT, PC;INTELLECTUAL PROPERTY ATTORNEYS, 7225 BEVERLY ST., ANNANDALE, VA, 22003, US

(73) Assignee: Darfon Electronics Corp., Taoyuan (TW)

(21) Appl. No.: 12/638,271

(22) Filed: Dec. 15, 2009

(30) Foreign Application Priority Data
Dec. 17, 2008 (TW) 097222600

(51) Int. Cl. H01H 1/10

(52) U.S. Cl. 200/512

(57) ABSTRACT

A thin film switch comprises: a bottom thin film, having at least one bottom electric conductor mounted on a top surface thereof; a top thin film, disposed above the bottom thin film while spacing from the same by an interval, and configured with at least one top electric conductor on a bottom surface thereof corresponding to the bottom electric conductor while enabling the corresponding top and bottom electric conductors to be spaced from each other by an interval; at least one extrusion, disposed on a top surface of the top thin film corresponding to the top electric conductor while protruding out from the top surface by a specific height; wherein, when the extrusion is depressed, the top thin film is depressed by the pressing so as to enable the at least one top electric conductor to engage with the corresponding bottom electric conductor for constructing an electrical conduction.

### FIELD OF THE INVENTION

The present invention relates to a thin film switch, and more particularly, to a thin film switch with enhanced film switching operation and accuracy.

### BACKGROUND OF THE INVENTION

With rapid advance in thin film technology, thin film switch is becoming smaller, lighter and thinner that it is vastly used in all kinds of electronic devices. Moreover, since it will not generate loud noise while being pressed, it is especially suitable to be used in press keys or keyboards.

Please refer to FIG. 1, which shows a conventional press key structure with thin film switch. In FIG. 1, the thin film switch 10 comprises: two thin films 11, 12, and an insulation film 13 sandwiched between the two thin films 11, 12. Moreover, there are two electric conductors 111, 121 disposed respectively on the two thin films in a face-to-face manner 11, 12 at positions corresponding to each other; and there is a membrane key 20 arranged above the thin film switch 10 while being spaced from the same by a specific distance D1 for safety precautious. When the press key structure of FIG. 1 is being pressed by a user using a finger 30 precisely at a position corresponding to the two electric conductors 111, 121, as shown in FIG. 2, the two electric conductors 111, 121 will be forced to engage with each other and thus cause an electrical conduction. However, since the exact position relating to the two electric conductors 111, 121 is concealed under the membrane key 20 in addition to the sizes of the two electric conductors 111, 121 can be relatively very small, it is common that the pressing of the user is not exerted exactly on the two electric conductors 111, 121 even if there is a marking on the membrane key 20 indicating the pressing position. It is possible for the user to press the press key several times before the thin film switch 10 can be engaged accurately that it is not only a waste of time, but also the multiple futile pressings are going to cause wear and tear to the press key, especially when the press key is built with weaker rigidity. In addition to the cause of multiple futile pressings, the pressing at erroneous position might not be able to engage the two electric conductors 111, 121 if the pressing force is not large enough.

### SUMMARY OF THE INVENTION

In view of the disadvantages of prior art, the primary object of the present invention is to provide a thin film switch with enhanced film switching operation and accuracy.

To achieve the above object, the present invention provides a thin film switch is disclosed, which comprises: a bottom thin film, having at least one bottom electric conductor mounted on a top surface thereof; a top thin film, being disposed above the bottom thin film while spacing from the bottom thin film by a specific interval, and configured with at least one top electric conductor on a bottom surface thereof corresponding in position to the at least one bottom electric conductor while enabling the corresponding top and bottom electric conductors to be spaced from each other by a specific interval; at least one extrusion, disposed on a top surface of the top thin film corresponding in position to the at least one top electric conductor while arranging the same to be protruding out from the top surface by a specific height; wherein, when the at least one extrusion is being depressed, the top thin film is brought along to be depressed by the pressing so as to enable the at least one top electric conductor to engage with the corresponding at least one bottom electric conductor for constructing an electrical conduction.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 is a sectional view of a press key structure with a conventional thin film switch.

FIG. 2 is a cross sectional diagram showing the press key structure of FIG. 1 as it is being pressed.

FIG. 3 is a sectional view of a press key structure with a thin film switch according to an embodiment of the invention.

FIG. 4 and FIG. 5 are cross sectional diagrams showing the press key structure of FIG. 1 as it is being pressed in different situations.

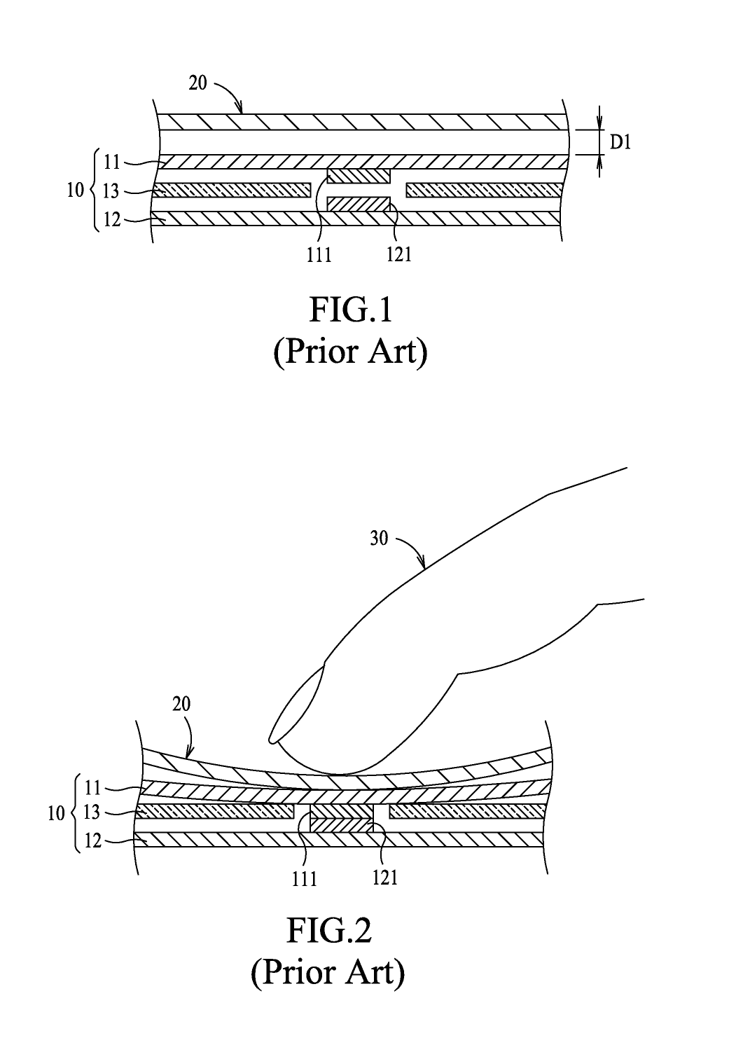

### DESCRIPTION OF THE EXEMPLARY EMBODIMENTS

For your esteemed members of reviewing committee to further understand and recognize the fulfilled functions and structural characteristics of the invention, several exemplary embodiments cooperating with detailed description are presented as the follows.

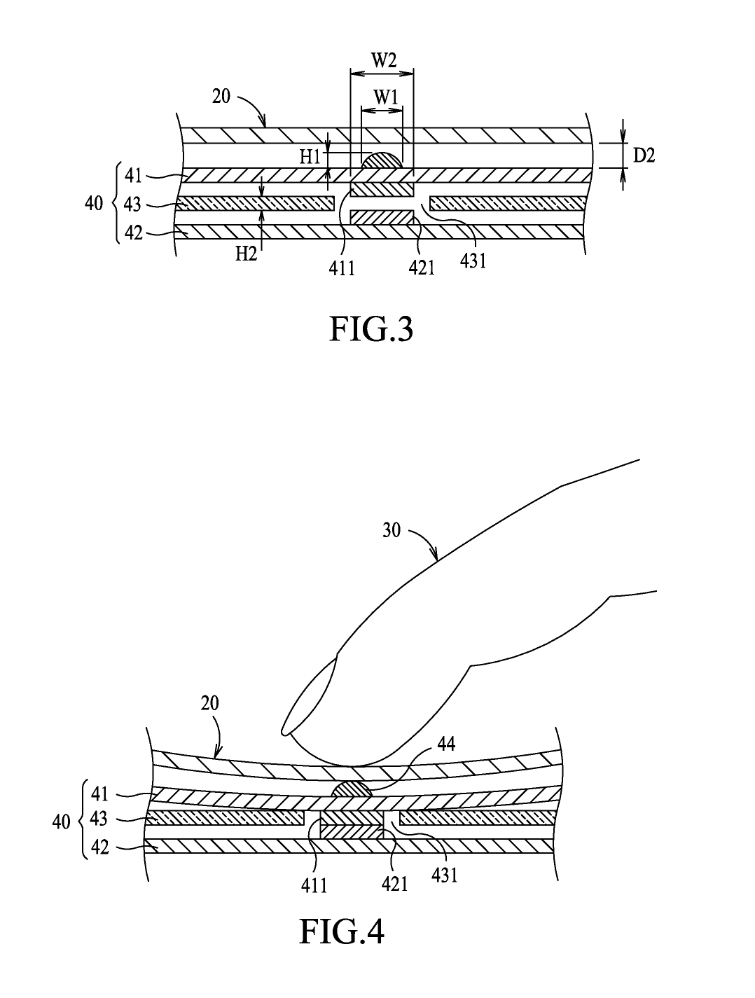

Please refer to FIG. 3, which is a sectional view of a press key structure with a thin film switch according to an embodiment of the invention. In FIG. 3, a thin film switch 40 is disclosed, which comprises: a bottom thin film 42, having a bottom electric conductor 421 mounted on a top surface thereof; a top thin film 41, being disposed above the bottom thin film 42 while spacing from the bottom thin film 42 by a specific interval, and configured with a top electric conductor 411 on a bottom surface thereof at a position corresponding the bottom electric conductor 421 while enabling the corresponding top and bottom electric conductors 411, 421 to be spaced from each other by a specific interval; and an one insulation film 43, sandwiched between the top thin film 41 and the bottom thin film 42 while being configured with a hollowed area 431 at a position corresponding to the top electric conductor 411 and the bottom electric conductor 421 so as to be provided for allowing the corresponding top and bottom electric conductors 411, 421 to piece therethrough when pressed for forming an electrical conduction. Moreover, there are circuits being formed respectively on the top thin film 41 and the bottom thin film 42. It is noted that the insulation film 43 is also being arranged spacing from the top thin film 41 and the bottom thin film 42 respectively by a specific interval, that along with the other intervals in the construction are provided for preventing erroneous electrical conduction from being engaged by unintentional pressing.

The thin film switch 40 of the present invention is characterized in that: there is an extrusion 44 being disposed on a top surface of the top thin film 41 at a position corresponding to the top electric conductor 411 while arranging the same to be protruding out from the top surface by a specific height H1. In an exemplary embodiment of the invention, specific height H1 is larger than the thickness H2 of the insulation film 43; and the area W1 of the extrusion 44 is not larger than the area W2 of the top electric conductor 411. Moreover, the extrusion 44 can be formed on the top surface of the top thin film 41 by imprinting or adhering, whereas the extrusion 44 can be made of any material only if it is hard enough for preventing the same from deformation while being pressed. In addition, there can be a press key 20, being arranged above the thin film switch 40 while arranging the two to be spaced from each other by a specific interface D2 for preventing erroneous electrical conduction from being engaged by unintentional pressing. Generally, the press key 20 is arranged at a position corresponding to the extrusion 44 and there are usually marking on the surface of the press key 20 to be used as indication for directing a user to press exactly on the top electric conductor 411.

As shown in FIG. 4, when the press key 20 is pressed by a user's finger 30, first, the press key 20 is forced to press on at extrusion 411, and then, the top thin film 41 will be brought along to be depressed by the pressing of the extrusion 44 so as to enable the top electric conductor 411 to engage with the corresponding bottom electric conductor 421 for constructing an electrical conduction, and thus simultaneously enabling the circuits on the top thin film 41 and the bottom thin film 42 to be conducted. By the arrangement of the aforesaid extrusion 44, a comparative smaller pressing force from the user that is exerted on the press key 20 will be sufficient for causing the electrical conduction. Therefore, not only it is comparatively easier to operate, but also the press key 20 can enjoy a longer lifespan since small pressing force will result in smaller deformation in the press key 20 when it is being pressed and thus lower the risk of being damaged by pressing.

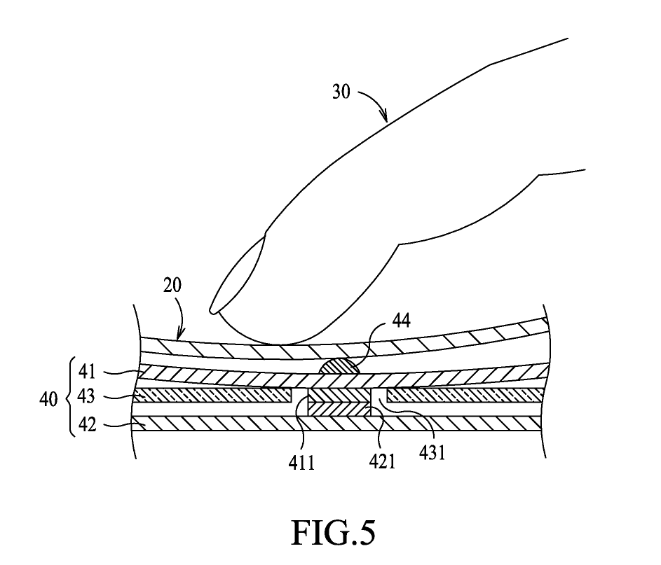

Please refer to FIG. 5, which is a schematic diagram showing a situation that the user's finger is not press exactly on a position corresponding to the top electric conductor in the thin film switch of the present invention. As shown in FIG. 5, by the arrangement of the extrusion 44, even when the user's finger 30 is not press on the press key 20 at exactly the position corresponding to the top electric conductor 411 in the thin film switch 40, the press key 20 still will press on the extrusion 44 which is going to bring along the top thin film 41 to be depress by the pressing of the extrusion 44, and thereby, enables the top electric conductor 411 to engage with the corresponding bottom electric conductor 421 for constructing an electrical conduction. Accordingly, the press key 20 can be engaged accurately simply by one touch without having to press the press key several times, that not only it is easier and faster in operation, but also the press key 20 can be prevented form being damaged by multiple futile pressing.

It is noted that the thin film switches disclosed in the foregoing embodiments are only used as illustrations and are not limited thereby. The aforesaid thin film switch 40 can be applied to those press key with scissor-type structure or common rubber press keys, that is functioning in a way similar to the previous description and thus will not be described further herein.

Top sum up, the present invention provides a thin film switch with enhanced film switching operation and accuracy.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

What is claimed is:

1. A thin film switch, comprises:
a bottom thin film, having at least one bottom electric conductor mounted on a top surface thereof;
a top thin film, being disposed above the bottom thin film while spacing from the bottom thin film by a specific interval, and configured with at least one top electric conductor on a bottom surface thereof corresponding in position to the at least one bottom electric conductor while enabling the corresponding top and bottom electric conductors to be spaced from each other by a specific interval; and
at least one extrusion, disposed on a top surface of the top thin film corresponding in position to the at least one top electric conductor while arranging the same to be protruding out from the top surface by a specific height;
wherein, when the at least one extrusion is being depressed, the top thin film is brought along to be depressed by the pressing so as to enable the at least one top electric conductor to engage with the corresponding at least one bottom electric conductor for constructing an electrical conduction.

2. The thin film switch of claim 1, further comprising:
at least one insulation film, each being sandwiched between the top thin film and the bottom thin film while being configured with at least one hollowed area corresponding in position to the at least one top electric conductor and the at least one bottom electric conductor so as to be provided for allowing the corresponding top and bottom electric conductors to piece therethrough when pressed for forming the electrical conduction.

3. The thin film switch of claim 2, wherein the specific height of the at least one extrusion protruding out of the top surface of the top thin film is larger than the thickness of the at least one insulation film.

4. The thin film switch of claim 2, wherein the at least one insulation film is arranged spacing from the at least one top electric conductor and the at least one bottom electric conductor respectively by a specific interval.

5. The thin film switch of claim 1, wherein the at least one extrusion is formed on the top surface of the top thin film by a means of imprinting.

6. The thin film switch of claim 1, wherein the at least one extrusion is formed on the top surface of the top thin film by a means of adhering.

7. The thin film switch of claim 1, wherein the area of the at last one extrusion is not larger than that of the at least one top electric conductor.

8. The thin film switch of claim 1, wherein there are circuits being formed respectively on the top thin film and the bottom thin film, and the circuits is conducted as soon as the electrical conduction is constructed by the engagement of the at least one top electric conductor and the at least one bottom electric conductor.

9. A thin-film press key, comprises:
a thin film switch, further comprising:
a bottom thin film, having at least one bottom electric conductor mounted on a top surface thereof;
a top thin film, being disposed above the bottom thin film while spacing from the bottom thin film by a specific interval, and configured with at least one top electric conductor on a bottom surface thereof corresponding in position to the at least one bottom electric conductor while enabling the corresponding top and bottom electric conductors to be spaced from each other by a specific interval; and
at least one extrusion, disposed on a top surface of the top thin film corresponding in position to the at least one top electric conductor while arranging the same to be protruding out from the top surface by a specific height;
and
a press key, disposed above the thin film switch at a position corresponding to the at least one extrusion;
wherein, when the press key is being pressed, the press key is forced to press on at least one extrusion, and thereby, the top thin film is brought along to be depressed by the pressing so as to enable the at least one top electric conductor to engage with the corresponding at least one bottom electric conductor for constructing an electrical conduction.

10. The thin-film press key of claim 9, further comprising:
at least one insulation film, each being sandwiched between the top thin film and the bottom thin film while being configured with at least one hollowed area corresponding in position to the at least one top electric conductor and the at least one bottom electric conductor so as to be provided for allowing the corresponding top and bottom electric conductors to piece therethrough when pressed for forming the electrical conduction.

11. The thin-film press key of claim 10, wherein the specific height of the at least one extrusion protruding out of the top surface of the top thin film is larger than the thickness of the at least one insulation film.

12. The thin-film press key of claim 10, wherein the at least one insulation film is arranged spacing from the at least one top electric conductor and the at least one bottom electric conductor respectively by a specific interval.

13. The thin-film press key of claim 9, wherein the at least one extrusion is formed on the top surface of the top thin film by a means of imprinting.

14. The thin-film press key of claim 9, wherein the at least one extrusion is formed on the top surface of the top thin film by a means of adhering.

15. The thin-film press key of claim 9, wherein the area of the at last one extrusion is not larger than that of the at least one top electric conductor.

16. The thin-film press key of claim 9, wherein there are circuits being formed respectively on the top thin film and the bottom thin film, and the circuits is conducted as soon as the electrical conduction is constructed by the engagement of the at least one top electric conductor and the at least one bottom electric conductor.
